(19) United States
(12) Patent Application Publication
(10) Pub. No.: US 2025/0091555 A1
(43) Pub. Date: Mar. 20, 2025

(54) METHOD FOR OPERATING AN ELECTROMECHANICAL SERVICE BRAKE OF A VEHICLE

(71) Applicant: ZF Active Safety GmbH, Koblenz (DE)

(72) Inventors: Stefan Grieser-Schmitz, Koblenz (DE); Florian Gerhartz, Buechel (DE); Patrick Mueller, Mayen (DE)

(21) Appl. No.: 18/884,564

(22) Filed: Sep. 13, 2024

(30) Foreign Application Priority Data
Sep. 15, 2023 (DE) 102023125075.2

(51) Int. Cl. B60T 8/171; B60T 8/172; B60T 8/88; B60T 8/92

(52) U.S. Cl. CPC B60T 8/171; B60T 8/172; B60T 8/885; B60T 8/92; B60T 2220/04; B60T 2240/02; B60T 2250/00; B60T 2250/03; B60T 2250/04; B60T 2270/402

(57) ABSTRACT

In a method for operating a electromechanical service brake of a vehicle, wherein the electromechanical service brake comprises a servomotor, which moves a component of the service brake in order to generate a braking force, and a motor-position sensor, which registers a displacement-specific position of the servomotor, a failure of the motor-position sensor is registered, and a feedback control of the servomotor by a motor-position signal from the motor-position sensor is replaced by triggering the servomotor on the basis of at least one servomotor-specific or vehicle-dynamics-specific parameter that is independent of the motor-position sensor.

### CROSS-REFERENCE TO RELATED APPLICATIONS

This application claims priority to DE Patent Application No. 102023125075.2 filed on Sep. 15, 2023, the disclosure of which is incorporated herein by reference in its entirety.

### TECHNICAL FIELD

The disclosure relates to a method for operating an electromechanical service brake of a vehicle.

### BACKGROUND

Electromechanical service brakes are employed for the purpose of retarding the vehicle in the normal travel mode. In this process, a component for generating a braking action is relocated by an electric servomotor; for instance, a brake pad is brought into abutment against a brake disk by a spindle drive. As a rule, the servomotor is provided with a motor-position sensor, the signal of which is an exact measure of the displacement of the component and consequently a precise measure of the braking force generated. In the standard mode of the electromechanical service brake, the adjustment of the braking force is undertaken by a feedback control of the servomotor with the aid of the data of the motor-position sensor.

In the event of failure of the motor-position sensor, the electromechanical service brake is normally deactivated. But as a result of this, the service brake concerned can no longer contribute at all to the braking force generated overall in the braking system, even though, in principle, it would still be operational.

What is needed is to enhance the availability of a braking system of a vehicle also in case of a fault of the motor-position sensor.

### SUMMARY

A method for operating an electromechanical service brake of a vehicle is disclosed, wherein the electromechanical service brake comprises a servomotor which moves a component of the service brake in order to generate a braking force. The electromechanical service brake comprises a motor-position sensor which registers a displacement-specific position of the servomotor. The following steps are carried out:
registering a failure of the motor-position sensor and
replacing a feedback control of the servomotor by a motor-position signal from the motor-position sensor by a triggering of the servomotor on the basis of at least of one servomotor-specific or vehicle-dynamics-specific parameter that is independent of the motor-position sensor.

If, by reason of a fault in the path of the motor-position sensor, the motor-position signal is no longer available, the service brake can nevertheless continue to be operated in an emergency mode, i.e., limp-home mode, without the motor-position sensor. In this way, it is possible, also in the case of a fault, to continue to build up a braking force by the servomotor with restricted or limited function of the service brake, and the service brake concerned does not have to be deactivated completely.

The servomotor-specific parameter is, for instance, a motor current of the servomotor. From the current consumption of the motor, it is possible for a motor-current signal to be obtained, from which a rotation and a speed of rotation of the servomotor and, with the aid thereof, a distance travelled can be derived.

The at least one vehicle-dynamics-specific parameter may be, for instance, an actual vehicle deceleration, an actual vehicle speed, an actual wheel-slip of a wheel of the vehicle, and/or an actual yaw-rate of the vehicle.

In general, for the at least one servomotor-specific or vehicle-dynamics-specific parameter, any suitable characteristic variable of the servomotor, or of the vehicle, may be used that permits a statement about a rotation of the servomotor, or about a change in the vehicle dynamics, and that is still available after the failure of the motor-position sensor.

In one possible exemplary arrangement, in the event of dropout of the motor-position signal, the triggering of the servomotor is undertaken by a pure open-loop control of the servomotor on the basis of the at least one servomotor-specific or vehicle-dynamics-specific parameter. For this purpose, sufficiently precise characteristic maps for the respective variable can be recorded, for instance in advance, which are then capable of being drawn upon for the purpose of estimating the displacement of the servomotor and consequently the braking force currently being generated.

In another exemplary arrangement, the triggering is a feedback control of the servomotor on the basis of the at least one servomotor-specific or vehicle-dynamics-specific parameter. In this case, an internal control loop of the electromechanical service brake, which encompasses the servomotor and the motor-position sensor, is replaced by an external control loop that uses a superordinate servomotor-specific or vehicle-dynamics-specific variable by way of controlled variable. The motor current of the servomotor is capable of being used here by way of servomotor-specific variable. By way of vehicle-dynamics-specific variable, any suitable variable can be used, also independently of the braking system of the vehicle, that is permanently registered in the normal travel mode by sensors that are present on the vehicle, and that is influenced by the triggering of the electromechanical service brake. The aforementioned servomotor-specific or vehicle-dynamics-specific parameters represent examples of such variables. The suitable servomotor-specific or vehicle-dynamics-specific parameter(s) can therefore be employed by way of controlled variable instead of the motor-position signal.

In the event of failure of the motor-position sensor and dropout of the motor-position signal, the servomotor-specific or vehicle-dynamics-specific parameter is preferentially processed in the emergency mode to create a replacement signal which is passed to the servomotor.

The electromechanical service brake preferentially exhibits a request unit which receives an actuation signal which, for example, includes a measure of the intensity of the braking force to be generated and which generates from the actuation signal a request signal which is forwarded to the servomotor for the purpose of triggering. The request unit is, for example, connected to an actuation pedal of the electromechanical service brake, and the actuation signal corresponds to a position of the actuation pedal. The request unit could, of course, receive the actuation signal from a suitable control unit of the vehicle also independently of an actuation pedal.

In the emergency mode, the request signal is preferentially modified by the replacement signal.

In one exemplary arrangement, the electromechanical service brake includes a driver unit which is connected in suitable manner to at least one sensor in the vehicle and receives from this sensor a sensor signal relating to the at least one servomotor-specific or vehicle-dynamics-specific parameter, this sensor signal entering into the generation of the replacement signal.

The request unit and the driver unit may be part of a control system of the electromechanical service brake which is also used in the standard mode.

The processing of the at least one servomotor-specific or vehicle-dynamics-specific parameter to create the replacement signal can, for instance, take place in the request unit or in the driver unit.

### BRIEF DESCRIPTION OF THE DRAWINGS

The disclosure will be described in more detail in the following with the aid of an embodiment with reference to the appended Figures.

FIG. 1 shows a schematic representation of a braking system of a vehicle with an electromechanical service brake in a standard mode; and

FIG. 2 shows a schematic representation of the braking system from FIG. 1 in an emergency mode in the event of a dropout of a motor-position signal, during the implementation of a method according to the disclosure.

### DETAILED DESCRIPTION

The Figures show a portion of a braking system 10 of a vehicle, not represented in any detail, with an electromechanical service brake 12 which, comprises a brake actuator assigned to a vehicle wheel. The service brake 12 serves to decelerate the vehicle as desired in the normal travel mode, and is accordingly not a parking brake.

The braking force of the electromechanical service brake 12 is generated by a servomotor 14 which, for instance, includes a spindle drive which displaces a component of the service brake 12 by a predetermined displacement. The component is, for example, a brake pad which is pressed against a brake disk of the electromechanical service brake 12.

The request for provision of a braking force in the travel mode is undertaken by a request unit 16 which makes available a request signal S_{A} that correlates with the desired level of the braking force.

The request unit 16 may be, for instance, connected to an actuation pedal 18 which is actuated by a driver of the vehicle and which transmits an actuation signal S_{B} to the request unit 16. But it is also possible that the request unit 16 receives the actuation signal S_{B} from another vehicle unit, for example, in connection with an autonomous travel mode.

In the example represented here, the request signal S_{A} is passed to a driver unit 20 which, in turn, operates the servomotor 14.

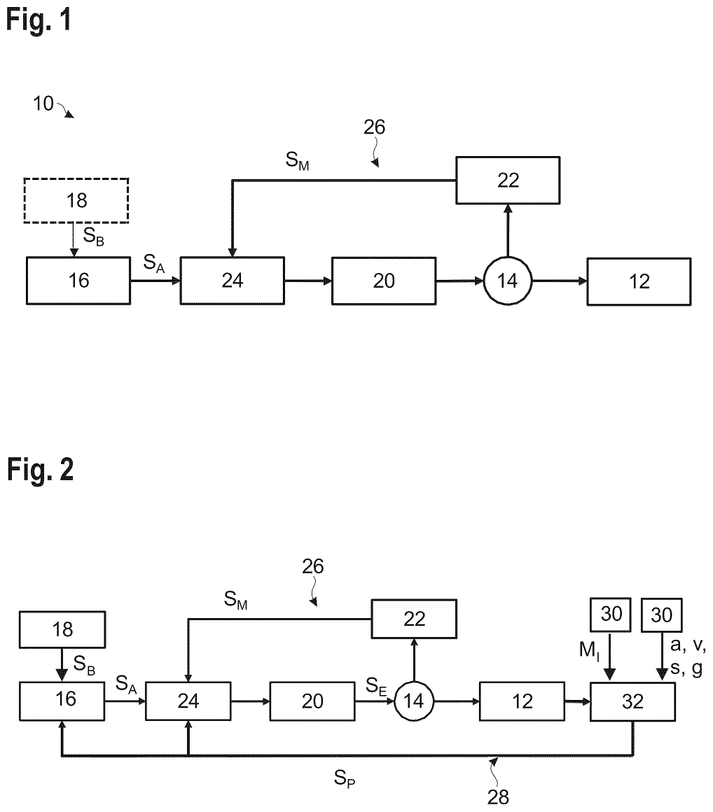

FIG. 1 shows the braking system 10 in a standard mode.

The servomotor 14 is connected to a motor-position sensor 22 which registers a displacement-specific position of the servomotor 14 and provides a motor-position signal S_{M} which is passed to a triggering unit 24.

The triggering unit 24 here is connected between the request unit 16 and the driver unit 20.

In general, the request unit 16, the driver unit 20 and the triggering unit 24 may have been configured as separate components or may have been entirely or partially integrated into one another or into another control unit of the braking system 10.

The servomotor 14, the motor-position sensor 22, the triggering unit 24 and the driver unit 20 constitute a control loop 26 which is indicated here as an internal control loop. The motor-position signal S_{M} is used by way of controlled variable in order to adjust a braking force that corresponds to the request signal S_{A}.

FIG. 2 shows the braking system 10 in an emergency mode in the case where the motor-position sensor 22 has failed or for some other reason in the path of the motor-position sensor the motor-position signal S_{M} is not available and consequently cannot be used by way of controlled variable.

Instead of the internal control loop 26, a different control loop 28, indicated here as an external control loop, is now used in order to adjust the braking force of the electromechanical service brake 12.

At least one suitable servomotor-specific or vehicle-dynamics-specific parameter is used by way of controlled variable, which is provided by a sensor 30 of the vehicle which is different from the motor-position sensor 22.

The sensor 30 is, for instance, a motor-current sensor which makes available an actual motor current M_{I} by way of sensor signal. The sensor 30 may also be a sensor that registers an actual vehicle deceleration a, an actual vehicle speed v, an actual wheel-slip s of a wheel of the vehicle, or an actual yaw-rate g of the vehicle, and for this purpose makes available a sensor signal S_{P}. It is also possible to register different servomotor-specific or vehicle-dynamics-specific parameters of such a type and to use them in combination.

At least one such sensor signal is registered by a general control unit 32 and is passed as signal S_{P} in the external control loop 28 to the request unit 16, to the triggering unit 24 or to the driver unit 20. The request unit 16, the triggering unit 24 and/or the driver unit 20 generate from the signal S_{P} and from the request signal S_{A} a replacement signal S_{E} which is used for the purpose of triggering the servomotor 14.

Since, by virtue of the action of the braking force of the electromechanical service brake 12 on the wheel of the vehicle, the servomotor-specific or vehicle-dynamics-specific parameter—that is to say, both the motor current M_{I}, the actual vehicle deceleration a, the actual vehicle speed v, the actual wheel-slip s, and/or the actual yaw-rate g of the vehicle—vary, the sensor signal that at least one of the sensors 30 provides also changes, so the signal S_{P} is capable of being used by way of controlled variable for the braking force.

The desired braking force of the electromechanical service brake 12 is consequently capable of being made available, at least within a restricted functional range, by the external control loop 28 also without use of the motor-position signal S_{M}.

In an alternative exemplary arrangement which is not shown, instead of the external control loop 28, a pure triggering is used for the purpose of generating the braking force of the electromechanical service brake 12. In this case, one or more servomotor-specific or vehicle-dynamics-specific parameters in the form of the signals S_{P} of one or more of the sensors 30 are communicated to the triggering unit 24 which, on the basis of the signals S_{P} as well as the request signal S_{A}, ascertains a replacement signal S_{E} and passes this signal to the servomotor 14 for the purpose of generating the desired braking force.

For example, an actual motor current of the servomotor 14 is used here by way of servomotor-specific parameter.

In this case, characteristic maps ascertained in advance, for instance, are drawn upon, in which a correlation of the data of the sensors 30—in this case, mainly of the motor-current sensor—with an actual braking force has been stored in a memory, in order to adjust the desired braking force at least approximately also without a feedback control. The use of such characteristic maps is, of course, possible also for other servomotor-specific or vehicle-dynamics-specific parameters, in particular an actual vehicle deceleration or an actual wheel-slip, in which case, for instance, further data, possibly relating to the gradient of the roadway or to the condition of the roadway, may also enter, in order to define the replacement signal S_{E} more precisely and to obtain a more precise adjustment of the braking force.

1. A method for operating an electromechanical service brake of a vehicle, wherein the electromechanical service brake includes a servomotor, which moves a component of the service brake in order to generate a braking force, and a motor-position sensor, which registers a displacement-specific position of the servomotor, with the method comprising the following steps:
registering a failure of the motor-position sensor and
replacing a feedback control of the servomotor by a motor-position signal from the motor-position sensor by a triggering of the servomotor on the basis of at least one servomotor-specific or vehicle-dynamics-specific parameter that is independent of the motor-position sensor.

2. The method according to claim 1, wherein the servomotor-specific parameter is a motor current of the servomotor.

3. The method according to claim 1, wherein the at least one vehicle-dynamics-specific parameter is an actual vehicle deceleration, an actual vehicle speed, an actual wheel-slip of a wheel of the vehicle, and/or an actual yaw-rate of the vehicle.

4. The method according to claim 1, wherein the triggering is an open-loop control of the servomotor on the basis of the at least one servomotor-specific or vehicle-dynamics-specific parameter.

5. The method according to claim 1, wherein the triggering is a feedback control of the servomotor on the basis of the at least one servomotor-specific or vehicle-dynamics-specific parameter.

6. The method according to claim 1, wherein the at least one servomotor-specific or vehicle-dynamics-specific parameter is processed to create a replacement signal which is passed to the servomotor.

7. The method according to claim 6, wherein the electromechanical service brake comprises a request unit which receives an actuation signal and which generates from the actuation signal a request signal which is forwarded to the servomotor for the purpose of triggering.

8. The method according to claim 7, wherein the request signal is modified by the replacement signal.

9. The method according to claim 6, wherein the electromechanical service brake includes a driver unit which is connected to at least one sensor in the vehicle and receives from this sensor a sensor signal relating to the at least one servomotor-specific or vehicle-dynamics-specific parameter, the sensor signal entering into the generation of the replacement signal.

10. The method according to claim 7, wherein the processing of the at least one servomotor-specific or vehicle-dynamics-specific parameter to create the replacement signal takes place in the request unit or in the driver unit of the electromechanical service brake.

11. The method according to claim 2, wherein the at least one vehicle-dynamics-specific parameter is an actual vehicle deceleration, an actual vehicle speed, an actual wheel-slip of a wheel of the vehicle, and/or an actual yaw-rate of the vehicle.

12. The method according to claim 8, wherein the electromechanical service brake includes a driver unit which is connected to at least one sensor in the vehicle and receives from this sensor a sensor signal relating to the at least one servomotor-specific or vehicle-dynamics-specific parameter, the sensor signal entering into the generation of the replacement signal.

13. The method according to claim 12, wherein the processing of the at least one servomotor-specific or vehicle-dynamics-specific parameter to create the replacement signal takes place in the request unit or in the driver unit of the electromechanical service brake.
